(19) United States
(12) Patent Application Publication
(10) Pub. No.: US 2018/0176440 A1
(43) Pub. Date: Jun. 21, 2018

(54) STRUCTURED-LIGHT-BASED EXPOSURE CONTROL METHOD AND EXPOSURE CONTROL APPARATUS

(71) Applicants: LITE-ON ELECTRONICS (GUANGZHOU) LIMITED, GUANGZHOU (CN); Lite-On Technology Corporation, Taipei (TW)

(72) Inventors: Hsing-Hung Chen, Taipei (TW); Chan-Min Chou, Taipei (TW)

(73) Assignees: LITE-ON ELECTRONICS (GUANGZHOU) LIMITED, GUANGZHOU (CN); Lite-On Technology Corporation, Taipei (TW)

(21) Appl. No.: 15/447,135

(22) Filed: Mar. 2, 2017

(30) Foreign Application Priority Data
Dec. 21, 2016 (CN) 201611189431.2

(51) Int. Cl. H04N 5/235; H04N 13/02

(52) U.S. Cl. CPC H04N 5/2352; H04N 13/0253

(57) ABSTRACT

The invention provides a structured-light-based exposure control method and an exposure control apparatus. The exposure control method includes: performing a structured light scanning operation on an object according to a plurality of exposure conditions to generate a plurality of corresponding image groups; determining an optimal exposure condition among the exposure conditions, wherein a disqualified exposure value of an image group corresponding to the optimal exposure condition is smaller than disqualified exposure values of the other image groups, and the disqualified exposure values are determined by a number of overexposed pixels and a number of insufficient-confidence pixels in each of the image groups; and calculating a stereo image of the object according to the image group corresponding to the optimal exposure condition.

### CROSS-REFERENCE TO RELATED APPLICATION

This application claims the priority benefit of China application serial no. 201611189431.2, filed on Dec. 21, 2016. The entirety of the above-mentioned patent application is hereby incorporated by reference herein and made a part of this specification.

### BACKGROUND OF THE INVENTION

### Field of the Invention

The invention relates to an exposure control method and an exposure control apparatus, and in particular, a structured-light-based exposure control method and an exposure control apparatus.

### Description of Related Art

In the field of the computer graphics, three-dimensional image acquisition and data analysis are required for geometrically measuring the appearance and contour of an object, and said geometric measurement technology has been applied in the fields of industrial design, reverse engineering, inspection of parts, digital archiving of cultural artifacts, and cultural relics and archaeology research.

The existing time-coded structured lights are able to provide considerably delicate scanning results. In the scanning method, the structured lights with different phase shifts and frequencies are projected onto a surface of an object, and an image capturing apparatus captures a plurality of images of the structured lights deformed by a contour of the surface of the object, so as to obtain complete surface information of the object through analyzing the images. Nevertheless, when the structured lights with the patterns are projected onto the surface of the object, overexposure may lead to erroneous stereo information; alternatively, insufficient-confidence caused by underexposure may cause the high error rate of calculating the stereo information.

### SUMMARY OF THE INVENTION

The invention provides a structured-light-based exposure control method and an exposure control apparatus for controlling exposure conditions to enhance image quality of stereo scanning.

The structured-light-based exposure control method of the invention is adapted for an exposure control apparatus including a projector and an image capturing apparatus. The exposure control method includes: performing a structured light scanning operation on an object according to a plurality of exposure conditions to generate a plurality of corresponding image groups; determining an optimal exposure condition among the exposure conditions, wherein a disqualified exposure value of an image group corresponding to the optimal exposure condition is smaller than disqualified exposure values of the other image groups, the disqualified exposure values being determined by a number of overexposed pixels and a number of insufficient-confidence pixels in each of the image groups; and calculating a stereo image of the object according to the image group corresponding to the optimal exposure condition.

The structured-light-based exposure control apparatus of the invention incudes a projector, an image capturing apparatus, and a processor. The processor is coupled to the projector and the image capturing apparatus. The processor instructs the projector and the image capturing apparatus to perform a structured light scanning operation on an object according to a plurality of exposure conditions to generate a plurality of corresponding image groups. The processor determines an optimal exposure condition among the exposure conditions. A disqualified exposure value of an image group corresponding to the optimal exposure condition is smaller than disqualified exposure values of the other image groups. The disqualified exposure values are determined by a number of overexposed pixels and a number of insufficient-confidence pixels in each of the image groups. The processor calculates a stereo image of the object according to the image group corresponding to the optimal exposure condition.

In light of the above, the exposure control method and the exposure control apparatus of the invention determine the optimal exposure condition among the plurality of exposure conditions and calculate the stereo image of the object according to the image group corresponding to the optical exposure condition.

To provide a further understanding of the aforementioned and other features and advantages of the invention, exemplary embodiments, together with the reference drawings, are described in detail below.

### BRIEF DESCRIPTION OF THE DRAWINGS

FIG. 1 is a block diagram illustrating an exposure control apparatus according to an embodiment of the invention.

FIG. 2 is a schematic diagram illustrating an exposure control apparatus according to an embodiment of the invention.

FIG. 3 is a flowchart illustrating an exposure control method according to an embodiment of the invention.

FIG. 4 is a schematic diagram illustrating an overexposure map according to an embodiment of the invention.

FIG. 5 is a schematic diagram illustrating a insufficient-confidence map according to an embodiment of the invention.

FIG. 6 is a schematic diagram illustrating a relationship between a phase angle and a confidence according to an embodiment of the invention.

FIG. 7 is a schematic diagram illustrating a relationship between exposure conditions and disqualified exposure values according to an embodiment of the invention.

### DESCRIPTION OF THE EMBODIMENTS

Several embodiments of the invention are described in detail hereinafter with reference to the figures. Regarding the reference numerals mentioned in the following description, the same reference numerals in different figures are deemed to represent the same or similar components. These embodiments are only part of the invention. Not all possible embodiments of the invention are disclosed here in this specification. More precisely, these embodiments are merely examples of the method and apparatus defined by the scope of the invention.

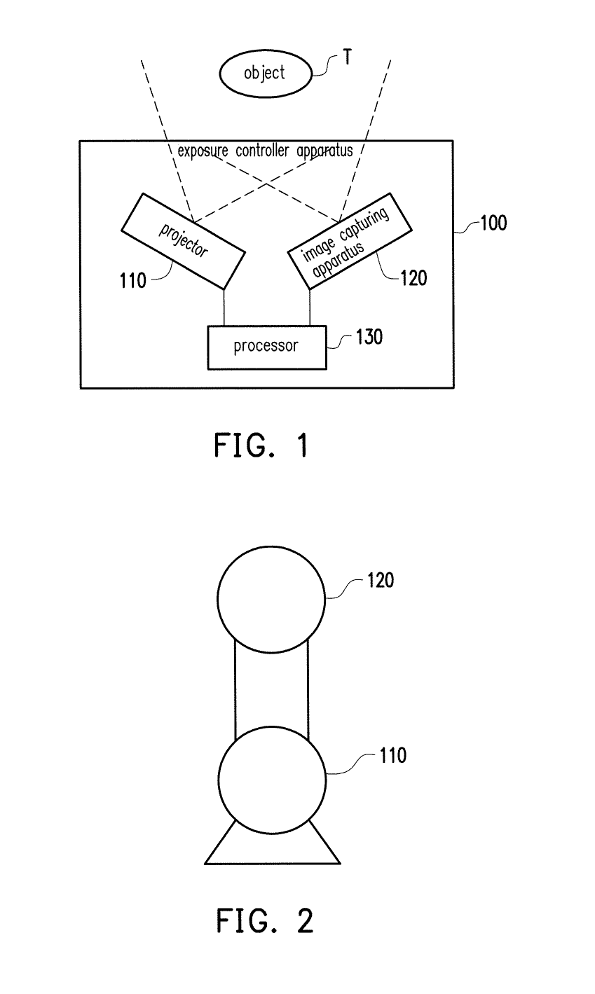

FIG. 1 is a block diagram illustrating an exposure control apparatus according to an embodiment of the invention. FIG. 2 is a schematic diagram illustrating an exposure control apparatus according to an embodiment of the invention. The illustrations are provided to make the description more comprehensible and are not meant to limit the invention.

Referring to FIG. 1 and FIG. 2, an exposure control apparatus 100 includes a projector 110, an image capturing apparatus 120, and a processor 130. The processor 130 is coupled to the projector 110 and the image capturing apparatus 120. The exposure control apparatus 100 scans an object T to obtain stereo information of the object T. In the present embodiment, the image capturing apparatus 120 is disposed above the projector 110, as shown in FIG. 2. However, the invention is not limited to the configuration in FIG. 2. For example, the projector 110 and the image capturing apparatus 120 may also be disposed horizontally to each other or in another manner.

In the present embodiment, the image capturing apparatus 120 is configured to capture an image of the object T. The image capturing apparatus 120 includes a camera lens and a photosensitive device. The camera lens is constituted by a lens, and the photosensitive device is configured to respectively sense the intensity of lights entering into the camera lens and thereby respectively generate images. The photosensitive device is, for example, a charge coupled device (CCD), a complementary metal-oxide semiconductor (CMOS) device, or another device, and the invention is not limited hereto.

In the present embodiment, the processor 130 is coupled to the projector 110 and the image capturing apparatus 120. The processor 130 is, for example, a central processing unit (CPU), a programmable microprocessor for general or specific purposes, a digital signal processor (DSP), a programmable controller, an application specific integrated circuit (ASIC), a programmable logic device (PLD), another similar device, or a combination of the foregoing devices.

People having ordinary skill in the art should understand that the exposure controller apparatus 100 further includes a data storage apparatus (not shown in the drawings) that is coupled to the projector 110, the image capturing apparatus 120, and the processor 130 for storing images and data. The data storage apparatus is, for example, a fixed or a movable random access memory (RAM) in any form, a read-only memory (ROM), a flash memory, a hard disc, another similar device, or a combination of the foregoing devices.

In the present embodiment, the processor 130 instructs the projector 110 to perform a structured light scanning operation on the object T; that is, the projector 110 is instructed to sequentially project structured lights with a plurality of scanning patterns on the object T to scan the object T. For example, the projector 110 sequentially projects structured lights with scanning patterns 1 to 6 on the object T. The scanning patterns 1 to 3 may have a first spatial frequency, and the scanning patterns 4 to 6 may have a second spatial frequency different from the first spatial frequency. The scanning patterns 1 to 3 and the scanning patterns 4 to 6 are sine wave-shaped patterns or cosine wave-shaped patterns, and each includes three different phase shifts (e.g., −120 degrees, 0 degree, and 120 degrees). When the structured lights with the scanning patterns 1 to 6 are projected on the object T, the processor 130 instructs the image capturing apparatus 120 to capture a plurality of images of the object T. Hence, the three different phase shifts of the scanning patterns 1 to 3 and the scanning patterns 4 to 6 respectively correspond to one of the plurality of images captured by the image capturing apparatus 120. More specifically, when the structured light with the scanning pattern 1 is projected on the object T, the image capturing apparatus 120 captures the image of the object T corresponding to the scanning pattern 1. Similar examples may apply when structured lights with other scanning patterns are projected on the object T. It should be noted that, although two sets of the structured lights with the scanning patterns of different spatial frequencies are adopted to scan the object T in the present embodiment, the invention is not limited hereto. In another embodiment, three or more sets of the structured lights with scanning patterns of different spatial frequencies may also be adopted to scan the object T to achieve an even more accurate scanning result. In addition, although the scanning patterns at the same spatial frequency include three different phase shifts in the present embodiment, the invention is not limited hereto. In another embodiment, scanning patterns at the same spatial frequency may include four or another number of different phase shifts.

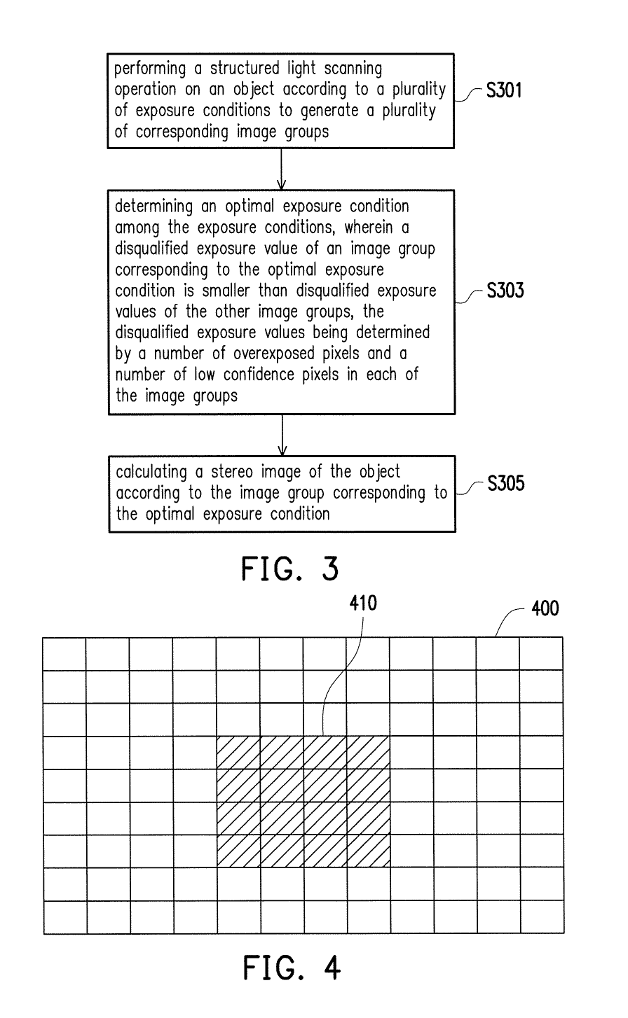

FIG. 3 is a flowchart illustrating an exposure control method according to an embodiment of the invention.

In step S301, a structured light scanning operation is performed on the object T according to a plurality of exposure conditions to generate a plurality of corresponding image groups. The exposure conditions may be a brightness of the projector 110, an aperture size of the image capturing apparatus 120, a simultaneous exposure time of the projector 110 and the image capturing apparatus 120, or a variation intensity range of the scanning patterns (e.g., scanning patterns with exposure values of 0 to 255 or scanning patterns with exposure values of 0 to 127). For example, when the exposure condition is the brightness of the projector 110, the processor 130 instructs the projector 110 to project structured lights with the scanning patterns 1 to 6 on the object T in different brightnesses. Therefore, the image capturing apparatus 120 can capture one image group (e.g., images 1 to 6 corresponding to the scanning patterns 1 to 6) in each projection brightness of the projector 110.

In step S303, an optimal exposure condition is determined among the exposure conditions. A disqualified exposure value of an image group corresponding to the optimal exposure condition is smaller than disqualified exposure values of the other image groups. The disqualified exposure value is determined by a number of overexposed pixels and a number of insufficient-confidence pixels in each image group.

Specifically, the processor 130 calculates an overexposure map of each image group and labels overexposed blocks in the overexposure map. For example, in FIG. 4, when the processor 130 calculates an overexposure map 400 of an image group, the processor 130 searches for an overexposed block 410 according to a predetermined exposure threshold value. Specifically, when an exposure value of a pixel in any one image in the image group is greater than the exposure threshold value, the processor 130 determines that this pixel is an overexposed pixel and labels this pixel in the overexposed block 410. Taking an 8-bit exposure value as an example, the exposure threshold value may be set at 250. The overexposure map 400 may be implemented by an equation below:

overexposure map=(image 1>exposure threshold value)* . . . *(image n>exposure threshold value),

wherein the image 1 to an image n represent exposure values of all pixels of the image 1 to the image n.

In the foregoing equation, n is a multiple of a number of the scanning patterns at the same spatial frequency. For example, in the present embodiment, n is 3 or 6.

In other words, the processor 130 determines by the foregoing equation whether each of the pixels in the image group is overexposed and calculates the overexposure map 400 including the overexposed block 410.

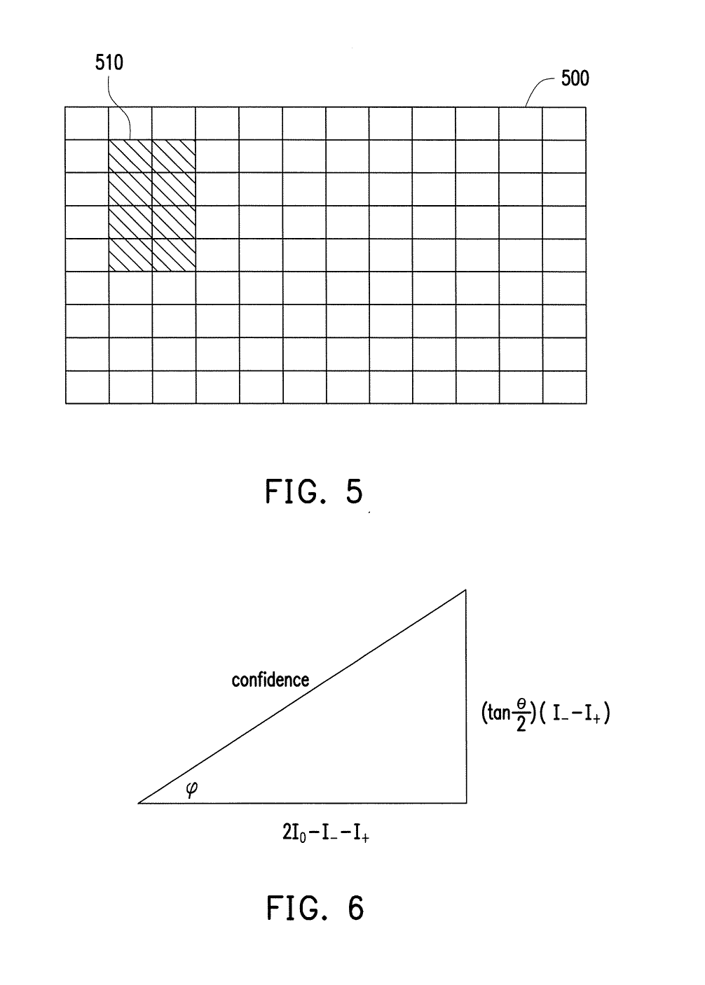

Moreover, the processor 130 calculates a insufficient-confidence map of each image group and labels insufficient-confidence blocks in the insufficient-confidence map. For example, in FIG. 5, when the processor 130 calculates a insufficient-confidence map 500 of an image group, the processor 130 searches for a insufficient-confidence block 510 according to a predetermined confidence threshold value. Specifically, when a confidence of a pixel in an image group is smaller than the confidence threshold value, it is determined that this pixel is a insufficient-confidence pixel and this pixel is labeled in the insufficient-confidence block 510, wherein the confidence is a variation in an exposure value of this pixel in the image group. The insufficient-confidence map 500 may be implemented by an equation below:

insufficient-confidence map=(I²+Q²)^{1/2}, wherein I=(2*image 2−image 1−image 3) and Q=tan(120/360*π)*(image 1−image 3),

wherein the images 1 to 3 represent exposure values of all pixels of the images 1 to 3.

Specifically, the exposure values of the pixels in the images 1 to 3 may be represented by equations (1), (2), and (3) below:

I₋=I_{base}+Iᵥₐᵣ cos(∅−θ) (1)

I₀=I_{base}+Iᵥₐᵣ cos(∅) (2)

I₊=I_{base}+Iᵥₐᵣ cos(∅+θ) (3)

In the equations (1) (3), I₋, I₀, and I₊ are respectively exposure value observation intensities of the pixels in the images 1 to 3, I_{base} corresponds to an ambient light intensity, Iᵥₐᵣ corresponds to a brightness of a structured light projected by the projector, ∅ is a phase angle, and θ is a phase shift. In the present embodiment, θ is 120 degrees.

$$\frac{( {I}_{-} - {I}_{+} )}{2 {I}_{0} - {I}_{-} - {I}_{+}} = \frac{tan ( Ø )}{tan ( \frac{θ}{2} )} \qquad ( 4 )$$

In the equation (4), by calculation of the portion to the left of the equals sign, dependency of the phase angle ∅ and the corresponding value I_{base} of the ambient light intensity and the corresponding value Iᵥₐᵣ of the brightness of the structured light projected by the projector is eliminated, a relationship between the phase angle ∅ and I₋, I₀, I₊, and the phase shift θ is obtained, as shown in the equation (5), and finally an equation (6) is derived from the equation (5).

$$\begin{matrix}{Ø}^{′} ( 0 , 2 π ) = arctan ( tan ( \frac{θ}{2} ) \frac{( {I}_{-} - {I}_{+} )}{2 {I}_{0} - {I}_{-} - {I}_{+}} ) & ( 5 ) \\ tan ϕ = \frac{tan ( \frac{θ}{2} ) ( {I}_{-} - {I}_{+} )}{2 {I}_{0} - {I}_{-} - {I}_{+}} & ( 6 )\end{matrix}$$

Accordingly, in the insufficient-confidence map, I is 2I₀−I₋−I₊ and Q is

$$tan ( \frac{θ}{2} ) ( {I}_{-} - {I}_{+} ) ,$$

and the confidence can be seen as a length of a hypotenuse of the triangle, as shown in FIG. 6.

According to the foregoing equations, as the variation of a pixel in an image group is lower, the calculated confidence is lower. When the confidence of a pixel in an image group is smaller than the confidence threshold value (e.g., 10), the processor 130 labels this pixel in the insufficient-confidence block 510.

After the processor 130 calculates the overexposed block 410 and the insufficient-confidence block 510, the number of the overexposed pixels and the number of the insufficient-confidence pixels can be obtained from the overexposed block 410 and the insufficient-confidence block 510. In the present embodiment, the processor 130 sets the disqualified exposure value as a total of the number of the overexposed pixels and the number of the insufficient-confidence pixels. However, the invention is not limited hereto. In another embodiment, the processor 130 may set the disqualified exposure value as a total of the number of the overexposed pixels multiplied by a first weighting parameter and the number of the insufficient-confidence pixels multiplied by a second weighting parameter.

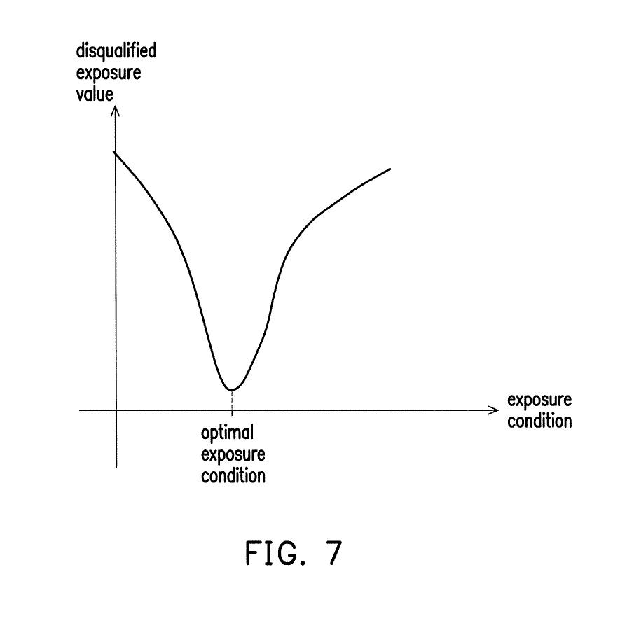

Next, the processor 130 calculates the disqualified exposure values corresponding to each of the exposure conditions and sets the exposure condition with the minimum disqualified exposure value as the optimal exposure condition, as shown in FIG. 7.

In step S305, a stereo image of the object is calculated according to the image group corresponding to the optimal exposure condition.

It shall be noted that in the present embodiment, the region for calculating the disqualified exposure value is the whole image displayed. However, the invention is not limited hereto. In another embodiment, the disqualified exposure value may be calculated only for a region of interest (ROI) to save a computation time.

In summary of the above, the exposure control method and the exposure control apparatus of the invention calculate the disqualified exposure values corresponding to each of the exposure conditions according to the number of the overexposed pixels and the number of the insufficient-confidence pixels in the image group corresponding to each of the exposure conditions. Then, the optimal exposure condition with the minimum disqualified exposure value is found among the plurality of exposure conditions. Finally, the stereo image is generated using the image group corresponding to the optimal exposure condition, thereby effectively enhancing the accuracy of stereo scanning.

Although the invention is disclosed in the embodiments above, the embodiments are not meant to limit the invention. Any person skilled in the art may make slight modifications and variations without departing from the spirit and scope of the invention. Therefore, the protection scope of the invention shall be defined by the claims attached below.

What is claimed is:

1. A structured-light-based exposure control method adapted for an exposure control apparatus comprising a projector and an image capturing apparatus, the exposure control method comprising:
performing a structured light scanning operation on an object according to a plurality of exposure conditions to generate a plurality of corresponding image groups;
determining an optimal exposure condition among the exposure conditions, wherein a disqualified exposure value of an image group corresponding to the optimal exposure condition is smaller than disqualified exposure values of the other image groups, the disqualified exposure values being determined by a number of overexposed pixels and a number of insufficient-confidence pixels in each of the image groups; and
calculating a stereo image of the object according to the image group corresponding to the optimal exposure condition.

2. The exposure control method according to claim 1, wherein the structured light scanning operation comprises:
sequentially projecting structured lights with a plurality of scanning patterns on the object by the projector to scan the object; and
capturing a plurality of images of the object by the image capturing apparatus when the structured lights with the scanning patterns are projected on the object.

3. The exposure control method according to claim 2, wherein a pixel is determined to be the overexposed pixel when an exposure value of the pixel in any one image in each of the image groups is greater than an exposure threshold value.

4. The exposure control method according to claim 2, wherein a pixel is determined to be the insufficient-confidence pixel when a confidence of the pixel in each of the image groups is smaller than a confidence threshold value, wherein the confidence is a variation in an exposure value of the pixel in each of the image groups.

5. The exposure control method according to claim 2, wherein the exposure conditions are a brightness of the projector, an aperture size of the image capturing apparatus, an exposure time of the projector and the image capturing apparatus, or a variation intensity of the scanning patterns.

6. The exposure control method according to claim 2, wherein the scanning patterns comprise specific patterns of a first spatial frequency and a second spatial frequency.

7. The exposure control method according to claim 2, wherein each of the structured lights with the scanning patterns comprises at least three different phase shifts and each of the phase shifts respectively corresponds to one of the images.

8. A structured-light-based exposure control apparatus comprising:
a projector;
an image capturing apparatus; and
a processor coupled to the projector and the image capturing apparatus,
wherein the processor instructs the projector and the image capturing apparatus to perform a structured light scanning operation on an object according to a plurality of exposure conditions to generate a plurality of corresponding image groups,
wherein the processor determines an optimal exposure condition among the exposure conditions, wherein a disqualified exposure value of an image group corresponding to the optimal exposure condition is smaller than disqualified exposure values of the other image groups, the disqualified exposure values being determined by a number of overexposed pixels and a number of insufficient-confidence pixels in each of the image groups,
wherein the processor calculates a stereo image of the object according to the image group corresponding to the optimal exposure condition.

9. The exposure control apparatus according to claim 8, wherein the processor instructs the projector to sequentially project structured lights with a plurality of scanning patterns on the object to scan the object, wherein the processor instructs the image capturing apparatus to capture a plurality of images of the object when the structured lights with the scanning patterns are projected on the object.

10. The exposure control apparatus according to claim 9, wherein a pixel is determined to be the overexposed pixel when an exposure value of the pixel in any one image in each of the image groups is greater than an exposure threshold value.

11. The exposure control apparatus according to claim 9, wherein a pixel is determined to be the insufficient-confidence pixel when a confidence of the pixel in each of the image groups is smaller than a confidence threshold value, wherein the confidence is a variation in an exposure value of the pixel in each of the image groups.

12. The exposure control apparatus according to claim 9, wherein the exposure conditions are a brightness of the projector, an aperture size of the image capturing apparatus, an exposure time of the projector and the image capturing apparatus, or a variation intensity of the scanning patterns.

13. The exposure control apparatus according to claim 9, wherein the scanning patterns comprise specific patterns of a first spatial frequency and a second spatial frequency.

14. The exposure control apparatus according to claim 9, wherein each of the structured lights with the scanning patterns comprises at least three different phase shifts and each of the phase shifts respectively corresponds to one of the images.
